(19) United States
(12) Patent Application Publication
(10) Pub. No.: US 2008/0251687 A1
(43) Pub. Date: Oct. 16, 2008

(54) SYSTEMS FOR CONSTRUCTING SAND STRUCTURES

(76) Inventor: Gerald Taufield, Tenafly, NJ (US)

Correspondence Address: GIBBONS P.C., ONE GATEWAY CENTER, NEWARK, NJ, 07102, US

(21) Appl. No.: 11/967,522

(22) Filed: Dec. 31, 2007

Related U.S. Application Data
(63) Continuation-in-part of application No. 11/734,032, filed on Apr. 11, 2007.

(51) Int. Cl. B28B 7/34

(52) U.S. Cl. 249/61

(57) ABSTRACT

Systems for constructing sand structures. The system comprises a plurality of mold blocks that can be assembled together such that their inner surfaces combine to form a internal cavity in the shape of a desired sand structure. There is also an external support used to retain the mold blocks in their assembled position. Sand is packed into the internal cavity formed by the collective internal surfaces of the mold blocks to form the sand structure. There may be a plurality of tiers of assembled mold blocks for constructing complex sand structures and there may be a mechanism to aid the user in grasping a mold block to facilitate the removal of the mold block to uncover the completed sand structure and there may also be some interlocking of adjacent mold blocks together. Once filled, the mold blocks are removed, thus creating the sand structure. A package contains all of the mold block and external supports necessary to construct various sand structures and may include weapons used to destroy a completed sand structure in playing a game.

### REFERENCE TO RELATED CASES

The present patent application is a continuation-in-part of U.S. patent application Ser. No. 11/734,032, filed Apr. 11, 2007, and entitled Systems For Constructing Sand Structures.

### FIELD OF THE INVENTION

The present invention relates to systems for constructing structures and, more particularly, to systems utilizing a plurality of mold blocks that are assembled together and retained in the assembled position by an external support and are filled with a material to create a unique structure.

### BACKGROUND OF THE INVENTION

One of the common and entertaining activities carried out at a beach is the construction of structures made up of compacted sand. Obviously, the structures run from the construction of rudimentary structures by children using only a shovel or simple toots to extremely difficult structures that are complex and produced by highly skilled persons.

There is also a time constraint on the construction of sand structures since most of the structures are produced on the beach by persons there for the day and therefore the structure must be finished within a relatively short period of time within daylight hours and prior to the onslaught of the tide that will eventually wash the structure away. As such, it is difficult for one having normal skill level to construct a solid, good appearing structure fairly quickly and with good results.

It would therefore be advantageous to have better tools to enable a person at the beach to construct good structures fairly rapidly and with good appearance of the structure. It would be further advantageous to be able to use such tool to enable a child to make a game out of constructing the sand structure with enthusiasm and make the day pleasant for the child.

### SUMMARY OF THE INVENTION

Accordingly, the present invention relates to systems for producing structures that can be used by one having minimum skill in building structures and yet produce a structure having a good appearance in a relatively short period of time. In the exemplary embodiment of the present invention, the invention will be described with respect to mold blocks and the construction of sand structures, however, it will be seen that the present invention is applicable to other materials, including, but not limited to, edible materials, latex, snow, wax and the like.

In one exemplary embodiment of the invention, there is provided the tools necessary to produce a sand structure and which can include a plurality of mold blocks that have inner surfaces and outer surfaces and where the configuration or shape of the inner surfaces combines to produce a desired shape of sand structure. Accordingly, the mold blocks are individually shaped and, in constructing a sand structure, the mold blocks are assembled or arranged together such that their combined inner surfaces create an internal cavity in the desired shape. The mold blocks are then maintained in the arranged position by means of an external support that holds and stabilizes the mold blocks so that sand can be introduced into the internal cavity surrounded by the various inner surfaces of the mold blocks.

After the sand has been introduced into that internal cavity, the external support can be removed and thereafter the mold blocks are free to be removed, by a carefull outward movement, so as to leave only the sand structure that is then in the shape of the combined inner surfaces of the mold blocks. In an exemplary embodiment, the external support may be a casing that abuts against the outer surfaces of the mold blocks and in another exemplary embodiment, the external support may be a plurality of substantially vertical upstanding rails that contact the outer surface of the mold blocks and hold them in their arranged orientation. As a still further exemplary embodiment, the mold blocks may be held together by straps or buckles spanning adjacent mold blocks.

In another exemplary embodiment of the invention, there may be multiple tiers of mold blocks placed atop each other to form a sand structure having additional height and possible increased complexity. In such embodiment, the plurality of vertically spaced apart internal cavities can be filed with sand sequentially up to the uppermost tier where a cap or other covering mold block can be used to create the upper tier of the sand structure. In the embodiment featuring multiple tiers, the mold blocks are removed by moving each mold block outwardly starting with the upper tier and working downwardly until only the sand structure remains.

As a further feature of the present invention, the mold blocks can be interlocked together to assist in the alignment and stability of the individual mold blocks forming the composite mold for creation of the sand structure. The mold blocks may also have openings, indentation or other grasping means to facilitate gripping the mold blocks to enable that user to readily pull the mold blocks outwardly in the removal thereof.

As a still farther feature of the present invention, an exemplary external support that surrounds a tier or level of mold blocks to retain that tier of mold blocks in their assembled condition can have an outwardly extending flange at the lower perimeter edge thereof As such, when a tier is completed or arranged together, the flange of the external support facilitates pushing the external support downwardly along the exterior of the assembled tier of mold blocks to retain the mold blocks in a fixed position for packing the sand into the mold block system. The presence of the flanges also facilitates the removal of the external support prior to when the mold blocks are removed to reveal the sand structure. With a complete tier, the flange on the external support or tension band may encircle the entire perimeter of the mold blocks making up a tier or the flange can extend only partially therearound.

As another feature, the individual mold blocks may be constructed such that the mold blocks themselves are substantially hollow wherein the mold block can be used as previously stated to create a sand structure, but, being substantially hollow, the mold blocks can be stacked or nested together to provide a compact package for shipping, storage and the like.

As part of the interlocking feature to create tiers of mold blocks, there may be a key and keyway system that provides an interlocking between the mold blocks of a particular tier to aid in alignment as well as a key and keyway system that provides an alignment aid for vertically adjacent constructed tiers. By use of the keying system the mold blocks are constrained to lateral movement so that the removal of the individual mold blocks of a tier can be removed laterally outwardly so as to minimally disrupt the sand structure thereby created, functioning as a guide for proper removal of mold blocks away from a completed sand structure.

In another exemplary embodiment the mold blocks have interchangeable face plates so that different sand structures can be created by changing the face plates, thus different faces can be used with the same mold blocks to add versatility to the overall system by simply interchanging one or more face plates with other interchangeable face plates. The interchangeable face plates can be sold along with system for constructing sand structures or sold separately

All of the components needed to carry out the construction of a sand structure in the manner heretofore described can be conveniently provided to the user in a package and which may also include one or more weapons such as toy bombs, toy guns and toy cannons that can be used by a child in damaging or destroying the sand structure constructed in accordance with the present invention. There may also be one or more objects that are placed within or at least partially within a sand structure that is constructed with the use of mold blocks as the sand is being packed into an internal cavity formed by the inner surfaces of the mold blocks in accordance with the present invention.

These and other features and advantages of the present invention will become more readily apparent during the following detailed description taken in conjunction with the drawings herein.

### BRIEF DESCRIPTION OF THE DRAWINGS

FIG. 1 is an exploded view illustrating mold blocks of an exemplary embodiment of the present invention;

FIG. 2 is a perspective view of the mold blocks of FIG. 1 in an assembled, arranged orientation;

FIG. 3 is a perspective view of the assembled mold blocks of FIG. 2 and illustrating an external support usable therewith;

FIG. 4A is a side view of the external support of FIG. 3 and FIG. 4B is a perspective view of the present invention assembled with the external support;

FIG. 5 is a perspective view of the system of FIGS. 1-4B of the present invention in its assembled form and filled with sand;

FIG. 6 is a perspective view of the present invention of FIGS. 1-5 illustrating the removal of the external support;

FIG. 7 is a perspective view of the present invention of FIGS. 1-6 illustrating the removal of the mold blocks from a sand structure;

FIG. 8 is a schematic illustrating an exemplary multi-tiered embodiment of present invention;

FIG. 9 is a perspective view of the FIG. 8 embodiment illustrating the assembling of an external support to the mold blocks;

FIG. 10 is a perspective view of the FIG. 8 embodiment illustrating the multi-tiered embodiment with external supports assembled thereto;

FIGS. 10A-10C are side cross sectional views illustrating various alignment systems that can be used with the multi-tiered embodiment;

FIG. 11 is a perspective view of the FIG. 8 embodiment illustrating the removal of the external supports;

FIG. 12 is a perspective view of the FIG. 8 embodiment illustrating the removal of the mold blocks;

FIG. 13 is a perspective view of a sand structure constructed in accordance with the FIG. 8 embodiment of the present invention;

FIGS. 14A-C are respectively views of an exemplary embodiment having a top cap including a schematic view of a multi-tiered embodiment for use with a top cap, a top view of the FIG. 14A structure and a side view of a top cap;

FIGS. 15A, 15B and 15C are perspective views, respectively, of exemplary single, double and three tiered embodiments of the present invention having a rectangular cross section;

FIGS. 16A, 16B and 16C are perspective views, respectively, of single, double and three tiered embodiments of the present invention having a square cross section;

FIGS. 17A, 17B and 17C are perspective views, respectively, of single, double and three tiered embodiments of the present invention having a circular cross section;

FIG. 18 is a schematic view of an assemblage of mold blocks of the present invention and illustrating an interlocking feature and an outer surface configured to facilitate a user gripping a mold block;

FIGS. 19 is an exploded view illustrating an exemplary embodiment of an interlocking feature useable with the present invention;

FIG. 20 is a schematic view illustrating the removal of a mold block using the outer surface configuration of FIG. 18;

FIGS. 21A-21G are various illustrations of sand structures that can be constructed using the present invention;

FIGS. 22A-22F are various illustrations of further sand structures that can be constructed using the present invention;

FIG. 23 is a schematic view of an alternative external support that can be used with the present invention;

FIG. 24 is a schematic view of a further alternative external support that can be used with the present invention;

FIGS. 25A-25C are schematic views of various weapons that can be used in connection with playing with a sand structure of the present invention and which can be included in a package with the components of the invention as supplied to a user;

FIGS. 26A-26C are schematic views illustrating a child using the weapons of FIG. 25A-25C in damaging or destroying one of such sand structures;

FIG. 27 is a schematic view of an exemplary multi-tier embodiment of the invention with external supports having flanges used to facilitate the installation and removal of the external supports;

FIG. 28 is a perspective view of exemplary, partially assembled mold blocks having interlocking features;

FIG. 29 is a perspective view of exemplary unassembled mold block tiers having vertical interlocking features;

FIG. 30 is a perspective view of exemplary mold blocks of the present invention nested together;

FIG. 31A is an exploded view of an exemplary mold block having an interchangeable face plate and FIG. 31B is an assembled view of the FIG. 31A embodiment;

FIG. 32A is a top view of an exemplary mold block having an interchangeable face plate and FIG. 32B is an assembled view of the FIG. 32A embodiment;

### DETAILED DESCRIPTION OF THE INVENTION

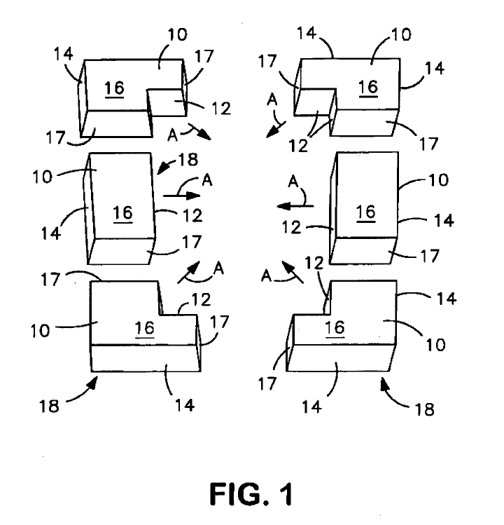

Referring now to FIG. 1, there is shown an exploded view of a plurality of mold blocks 10 used in the present invention. As can be seen, the mold blocks 10 each have an inner surface 12, an outer surface 14, top surface 16, side surfaces 17 and bottom surface 18. The inner surfaces 12 of each of the mold blocks 10 are specially designed so as to cooperate with other mold blocks 10 such that all of the inner surfaces combine together to form a particular sand structure, while the side surfaces generally abut against an adjacent mold block 10.

As will later be seen, therefore, the mold blocks 10 are placed on a relatively flat surface and are arranged together by moving the mold blocks 10 in the direction of the arrows A to form an arrangement of a mold blocks having a contiguous inner surface. There are six (6) mold blocks 10 illustrated in FIG. 1, however, more or less mold blocks can be used in carrying out the purpose of the present invention and depending upon the complexity or lack of complexity of the sand structure being constructed. In the embodiment of FIG. 1, the bottom surfaces 18 are larger in area than the top surfaces 16, such that the outer surfaces 14 taper inwardly in the upward direction. The purpose of the tapering will later become apparent. As can be seen, the mold blocks 10 are adapted to rest on the ground in order to carry out the present invention and the ground will normally be a beach where unlimited sand is available, however, the invention could be employed at other sites, such as a sand box at a playground or yard.

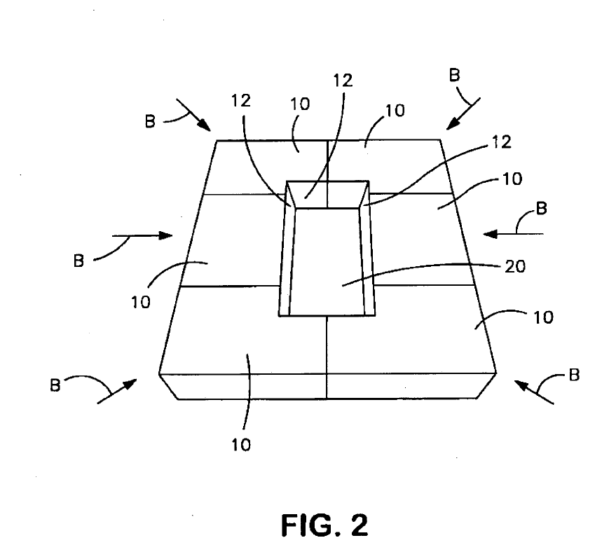

Turning to FIG. 2, there is shown a perspective view of the mold blocks 10 that have been arranged by converging the mold blocks 10 in the direction of the arrows B so as to create an internal cavity 20 that is formed or shaped in the configuration of the particular sand structure to be constructed. As such, all of the inner surfaces 12 form an internal contiguous inner perimeter that is used in forming the eventual sand structure.

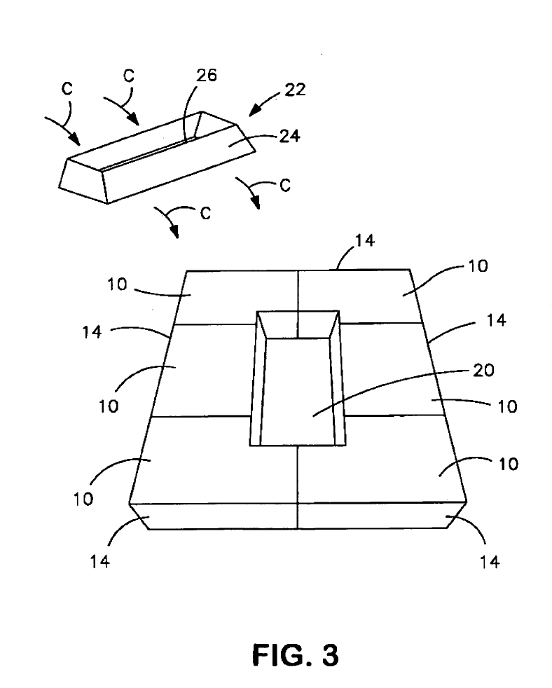

Next, in FIG. 3, there is a perspective view of the assembled mold blocks 10 as shown in FIG. 2 with the addition of an external support that is used to retain the mold blocks 10 in this arranged orientation. In FIG. 3, the external support is an outer casing 22 that is placed by the user over the mold blocks 10 so as to surround the outer perimeter made up of all of the contiguous outer surfaces 14 of the assembled mold blocks 10. Due to the aforedescribed taper of the outer casing 22 and the outer surfaces 14, the outer casing 22 can be readily slid over the mold blocks 10 to hold the mold blocks 10 firmly in their assembled condition.

The outer casing 22 can completely or at least partially surround the mold blocks 10 and may be made of any material having sufficient strength to retain the mold blocks 10 in their assembled positions including but not limited to metal, ceramic, plastic or any other suitable material. In FIG. 3, the outer casing 22 can be seen to have tapering inwardly tapering sides 24 defining an opening 26. The outer casing 22 is designed to fit snugly over the assembled mold blocks 10 by being moved in the direction of the arrows C.

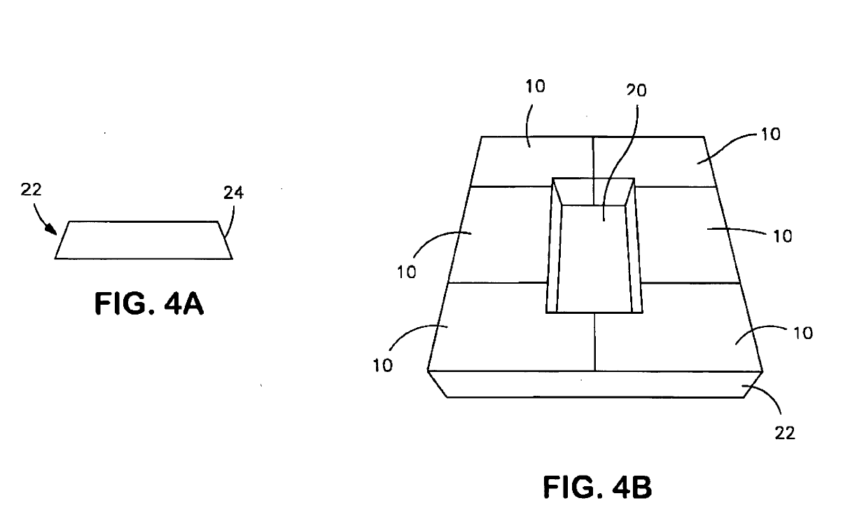

Turning next to FIG. 4A, there is shown a side view illustrating the inwardly tapering sides 24 of the outer casing 22 and, in FIG. 4B, the outer casing 22 has been positioned surrounding the mold blocks 10 to retain the mold blocks 10 in their assembled positions.

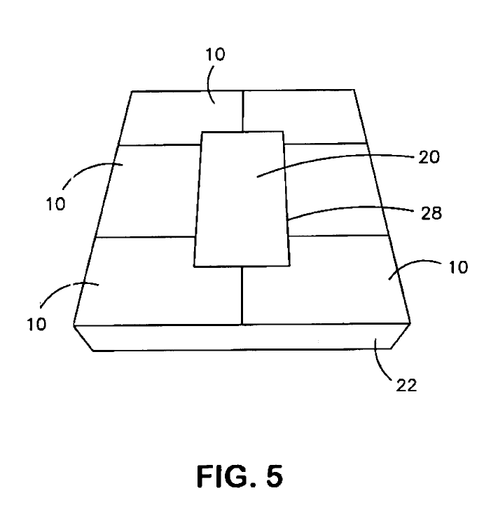

In FIG. 5, the assembled mold blocks of FIG. 4 can be seen and wherein the internal cavity 20 has been filled with sand that is packed for forming the sand structure 28.

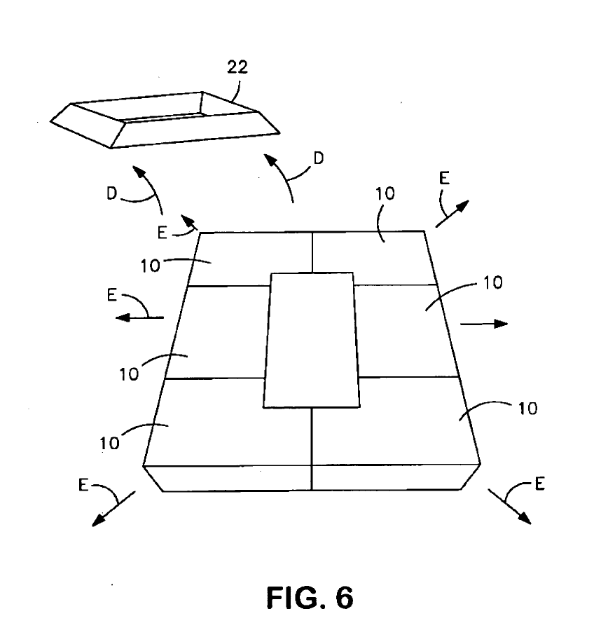

Turning now to FIG. 6, there is shown a perspective view of the present invention where the outer casing 22 has been removed by raising it upwardly and away from its position surrounding the mold blocks 10 generally in the direction of the arrows D. At this point, the mold blocks 10 are capable of being removed by sliding them directly outwardly and away from the sand structure 28 contained within the internal cavity 20 such as in the direction of the arrows E.

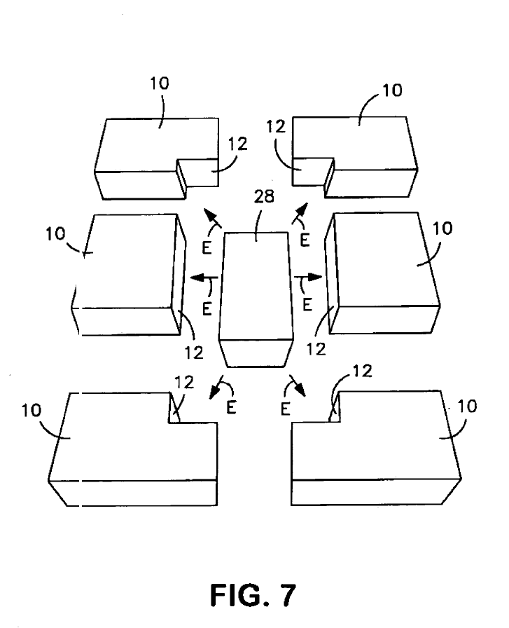

In FIG. 7, therefore, there is a perspective view of a sand structure 28 that remains after the removal of the mold blocks 10 and, as can be seen, the overall configuration of the sand structure 28 is determined by the combined inner surfaces 12 of the mold blocks 10.

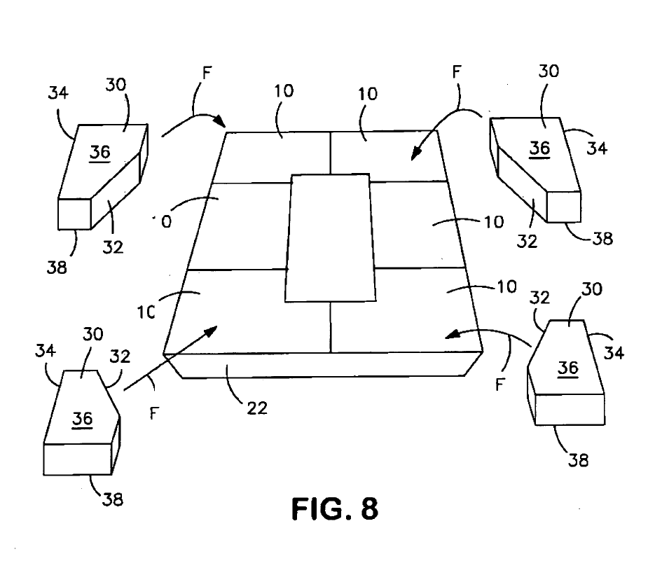

Turning next to FIG. 8, there is shown a perspective view of a exemplary embodiment having multiple tiers of mold blocks. As such, there can be seen the lower tier of mold blocks 10, using the same designation numbers as with FIGS. 1-7 and an upper tier comprising upper tier mold blocks 30, each having an inner surface 32, an outer surface 34, a top surface 36 and a bottom surface 38. As can be seen in FIG. 8, the upper tier mold blocks 30 are placed atop of the mold blocks 10 by movement generally in the direction of the arrows F to create a mold for a second tier for a sand structure to be formed. The outer casing 22 of the lower tier remains in place surrounding the mold blocks 10.

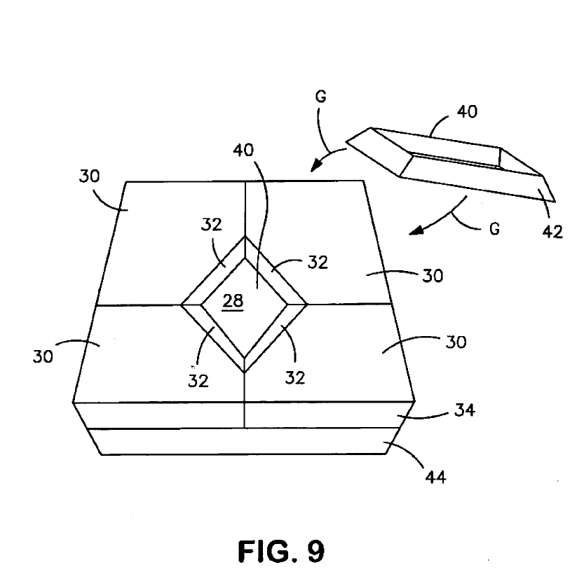

In FIG. 9, it can be seen that the upper tier mold blocks 30 are positioned in place creating an upper internal cavity 40 which is also to be packed with sand for forming the sand structure 28 atop of the lower tier 44 of the sand structure 28 and, as with the prior embodiment, the shape of the cavity 40, and, of course, also the sand structure, is determined by the collective and contiguous inner surfaces 32 of the upper tier mold blocks 30. An external support is also provided for the upper tier mold blocks 30 in the form of an upper outer casing 40 that is positioned over the upper tier mold blocks 30 by movement in the direction of the arrows C in the same manner as described with respect to the assembling of the lower tier. Again, the outer surfaces 34 of the upper tier mold blocks 30 and the sides 42 of the upper outer casing 40 can be tapered inwardly in the upper direction.

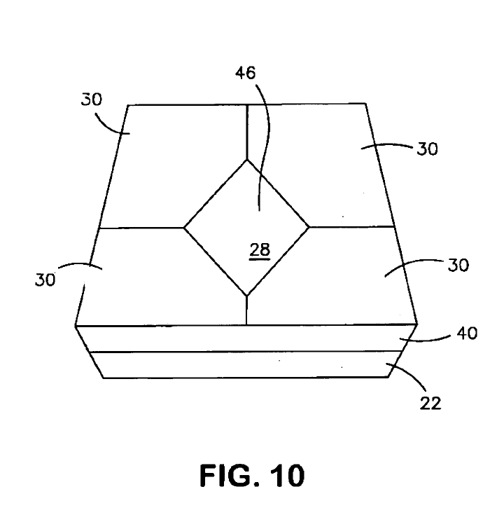

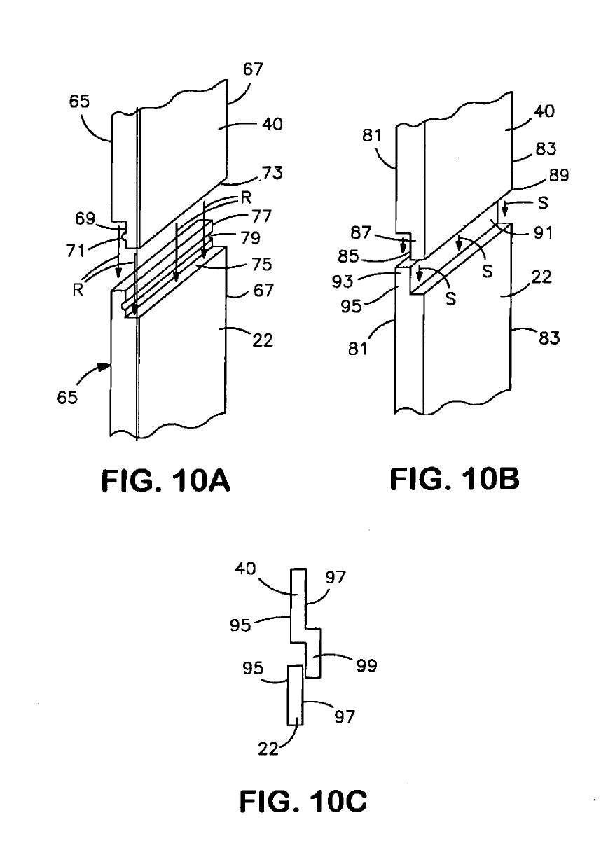

Turning next to FIG. 10, there is a perspective view of a multi-tier embodiment of the present invention wherein the upper outer casing 40 has been affixed to the upper tier by surrounding the upper tier mold blocks 30 and the upper tier 46 of the sand structure 28 has been packed with sand.

Turning now to FIGS. 10A, 10B and 10C, there is shown an exploded view of exemplary systems that can be used to align together any two vertically adjoining mold blocks by securing the outer casings together, using the outer casing 22 and the upper outer casing 40 of FIG. 10 as examples. Thus FIG. 10A shows a cutaway segment of the upper outer casing 40 and a lower, outer casing 22, each having an inside surface 65 and an outside surface 67. The upper outer casing 40 has a recess 69 with an elongated protrusion 71 that extends along, or at least partially along, the lower edge 73 of the upper outer casing 40. There is a similar recess 75 along the upper edge 77 of the outer casing 22 and having a elongated groove 79 disposed at least partially therealong. As such, to affix the upper outer casing 40 to the outer casing 22, the respective edges 73 and 77 are brought together by movement in the direction of the arrows R whereupon the elongated protrusion 71 enters into and nests within the elongated groove 79 to affix those components together.

In FIG. 10B, there is an exploded view of an alternative alignment system to that of FIG. 10A. In the exemplary alignment system of FIG. 10B, again there is shown a cutaway segment of the upper outer casing 40 and lower, outer casing 22, each having an inside surface 81 and an outside surface 83. The upper outer casing 40 has a recess 85 forming a downwardly directed flange 87 that extends along, or at least partially along, the lower edge 89 of the upper outer casing 40. There is a similar recess 91 along the upper edge 93 of the outer casing 22 forming an upwardly directed flange 95 disposed at least partially therealong. As such to align the upper outer casing 40 to the outer casing 22, the respective edges flanges 87, 95 are brought in contact with each other, in the direction of the arrows S, to frictionally engage the upper outer casing 40 to the outer casing 22.

In FIG. 10C there is a still further alignment system for the upper outer casing 40 and the outer casing 22 having inside surfaces 95 and outside surfaces 97 and wherein the upper outer casing 40 extends downwardly with an offset forming a downwardly directed flange 99 that extends over the outside surface 97 of the outer casing 22.

While the aforedescribed methods and devices for aligning two adjacent outer casings are exemplary embodiments, there are certainly other ways of aligning one outer casing with another outer casing consistent with the intent and purpose of the present invention.

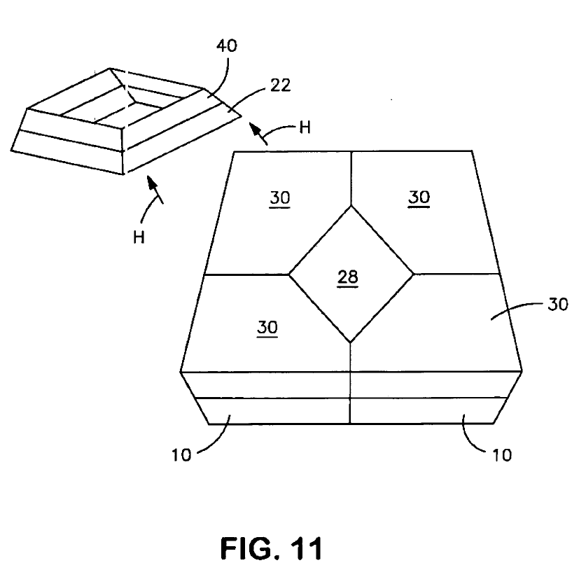

In FIG. 11, there is a perspective view of the multi-tier embodiment of the invention and wherein the outer casing 22 and the upper outer casing 40 have been removed generally in the direction of the arrows H, thereby leaving only the mold blocks 10 and the upper tier mold blocks 30 surrounding the sand structure 28. The outer casing 22 and upper outer casing 40 can be removed one at a time or removed together.

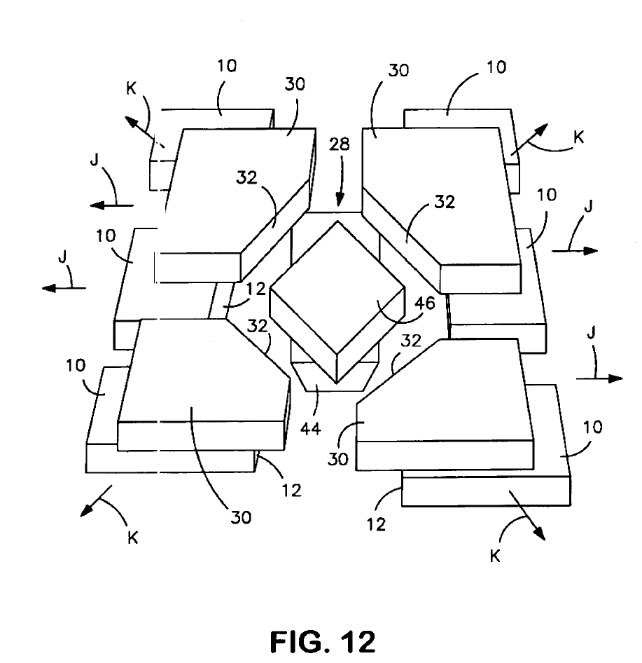

Turning now to FIG. 12, there is shown a perspective view illustrating the removal of the mold blocks 10 and the upper tier mold blocks 30 to reveal the two tiered sand structure 28 i.e. the lower tier 44 and the upper tier 46. The mold blocks 10 are pulled away along the path of the arrows J and the upper tier mold blocks. 30 along the path of the arrows K. As can be seen the lower tier 44 of the sand structure 28 has the shape of the contiguous inner surfaces 12 of the mold blocks 10 while the upper tier 46 has the shape of the contiguous inner surfaces 32 of the upper tier mold blocks 30 and that the two tiers have different shapes.

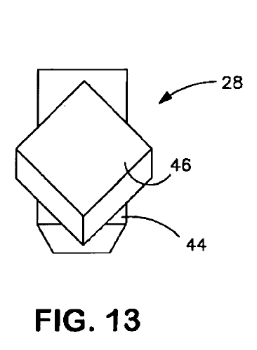

Finally, in FIG. 13, as to the multi-tier embodiment, there can be seen a sand structure 28 having different shapes for the lower tier 44 and the upper tier 46. Thus, with the multi-tier embodiment there may be two or more tiers used in constructing the sand structure and each may or may not have different inner surface configurations lending considerable versatility in the use of the present invention for constructing desired shapes of sand structures.

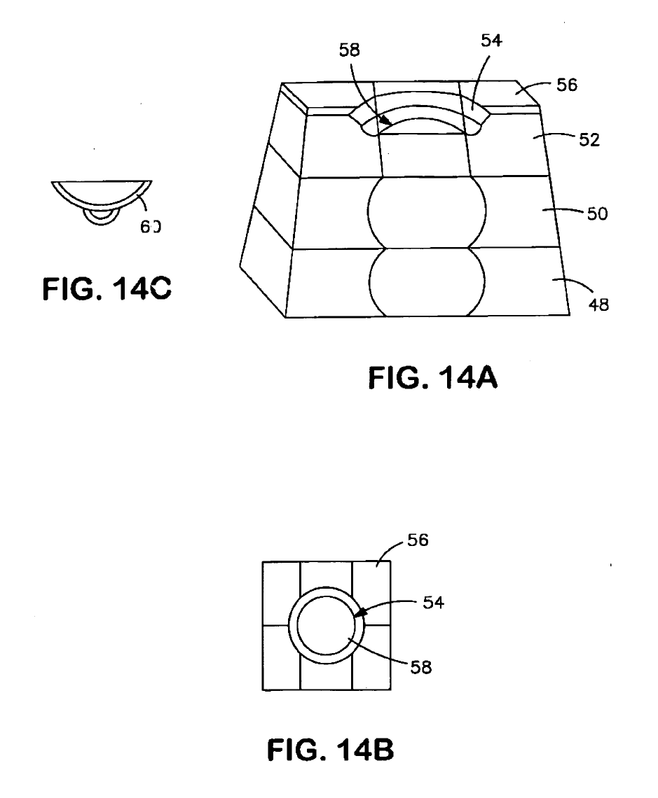

Turning now to FIGS. 14A, 14B and 14C, there can be seen, respectively, a cross sectional view of a multi-tier embodiment, a top view of the FIG. 14A embodiment and a perspective view of a covering for use with the FIG. 14A embodiment. In this embodiment, the top has a rounded top or “skull cap” instead of the flat top surface as shown in the prior embodiments. Thus, in FIG. 14A, there are three tiers; a lower tier 48, intermediate tier 50 and an upper tier 52. There is an inwardly tapered opening 54 formed in the upper surface 56 of the upper tier 52 and a recessed annulus 58 forming a seat at the upper surface 56 of the upper tier 52. That inwardly tapered opening 54 is also seen in FIG. 14B. As such, in FIG. 14C there is a cap 60 that is adapted to be filled with sand and then inverted and placed into the inwardly tapered opening 54 in order to create a curved top to the sand structure and any excess sand runs down into the recessed annulus 58.

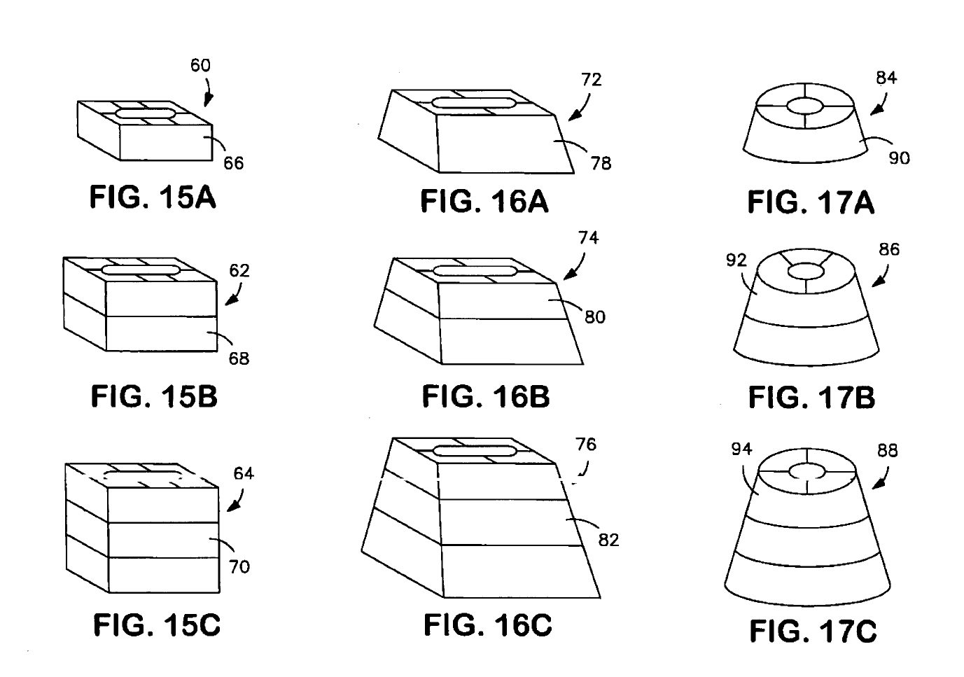

Turning next to FIGS. 15A-C, 16A-C and 17A-C, there are illustrated, various examples of some arrangements or assemblies of mold blocks that can be used to create sand structures using the present invention. For example, in FIGS. 15A, 15B and 15C, there is shown, respectively, a single tier 60, two tier 62 and a three tier 64 sets of mold blocks having their outer surfaces 66, 68 and 70, respectively, formed in the shape of rectangles; in FIGS. 16A, 16B and 16C there is shown, respectively, a single tier 72, two tier 74 and a three tier 76 sets of mold blocks having their outer surfaces 78, 80, 82, respectively, formed in the shape of squares and in FIGS. 17A, 17B and 17C, there is shown, respectively, a single tier 84 two tier 86 and a three tier 88 sets of mold blocks having their outer surfaces 90, 92 and 94, respectively, formed in a circular shape. While FIGS. 15A-C, 16A-C and 17A-C illustrate up to three tiers, it can be seen that there may be more than three tiers used in the construction of a sand structure and the tiers may have different outer shapes, for example, octagonal, hexagonal or other geometric shapes.

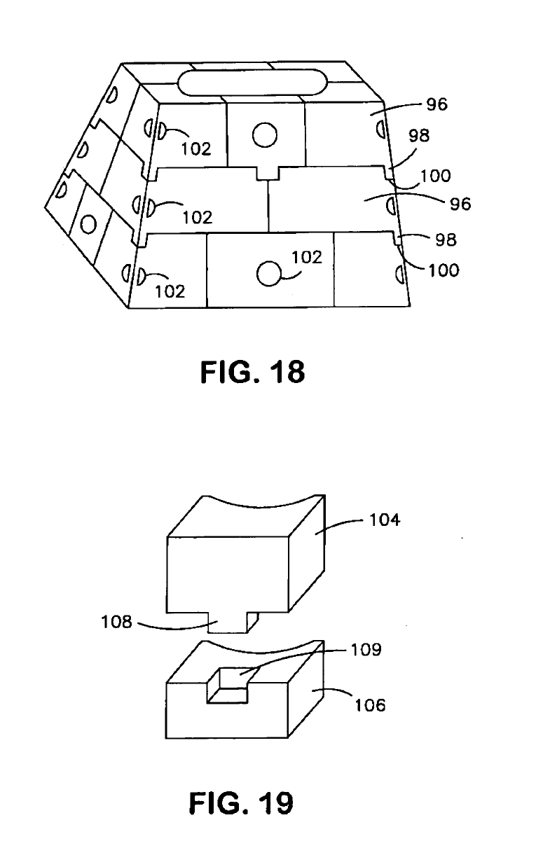

Turning now to FIG. 18, there is a perspective view of a multi-tier embodiment of the present invention and wherein there are interlocking devices that provide an interlock of respective tiers of the arranged mold blocks 96 of adjacent tiers. In the exemplary embodiment of FIG. 18, the interlocking devices are comprised of guide pegs 98 that extend downwardly so as to interfit within guide notches 100 formed on the next lower tier. As such there is an interlocking mechanism that holds the mold blocks 96 of the vertically disposed tiers together. The interlocking feature may be in some or all of the mold blocks 96.

As also can be seen in FIG. 18, there is also a surface configuration formed in one or more of the mold blocks 96 to facilitate a user getting a good grip on the particular mold block 96 to pull it out from the assembly of mold blocks 96 in freeing up the eventual sand structure as previously explained. The surface configuration can be, for example, an opening 102 in a mold block 96 and which can be grasped by the user in removing a mold block 96.

Turning to FIG. 19, there is an enlarged view of one interlocking mechanism that can be used with the present invention as described with respect to FIG. 18. As such, there can be seen an upper mold block 104 and a lower mold block 106. A guide peg 108 extends downwardly from the upper mold block 104 and interfits into the guide notch 109 formed in the lower mold block 106, thereby interlocking the upper mold block 104 with the lower mold block 106.

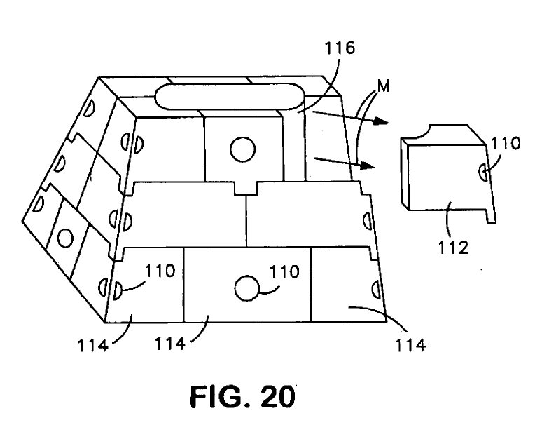

In FIG. 20, there is an example of the use of a surface configuration, such as opening 110, to remove a mold block 112 from a plurality of mold blocks 114 in the direction of the arrows M to reveal the sand structure 116. As can be seen, with a multiple tiered sand structure, the upper tier of mold blocks are initially removed and thereafter the user continues downwardly in removing the further mold blocks until all of the mold blocks are removed, leaving the sand structure.

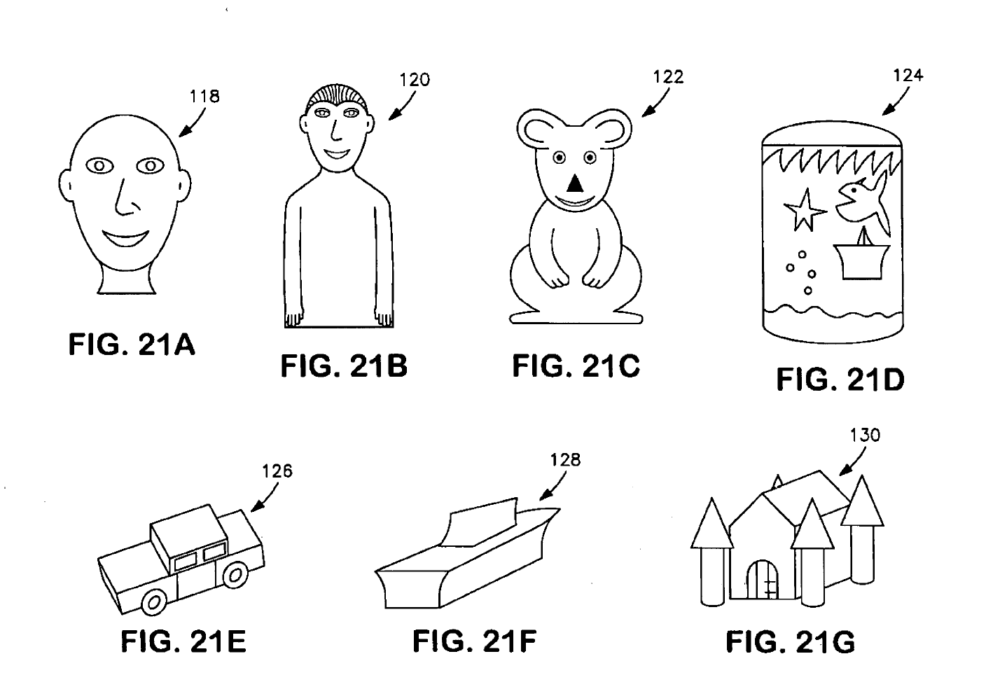

Turning to FIGS. 21A-21G, there are a number of various sand structures that can be formed using the single or multiple-tiered embodiments of the present invention and includes heads/faces 118 of FIG. 21A; torsos/bodies 120 of FIG. 21B; animal shapes 122 of FIG. 21C; art scenes and murals 124 of FIG. 21D; cars, trucks and other vehicles 126 of FIG. 21E; boats, ships and submarines 128 of FIG. 21F and buildings/castles and forts 130 of FIG. 21G.

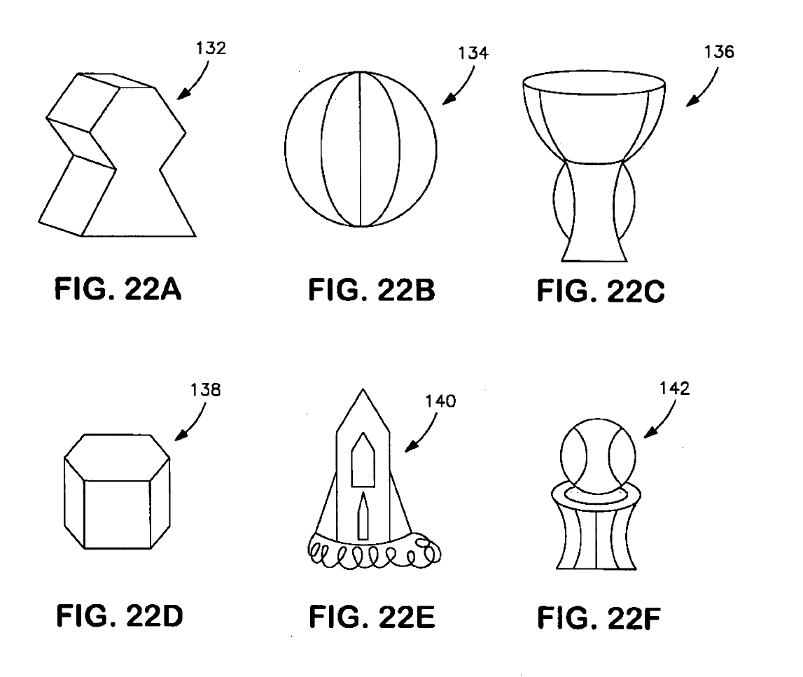

In FIGS. 22A-22F, there are shown further typical shapes of sand structures that can be constructed by the use of the present invention including freeform shapes 132 of FIG. 22A; globes/planets 134 of FIG. 223; trophies 136 of FIG. 22C; geometric shapes 138 of FIG. 22D; spaceships/rockets 140 of FIG. 22E and sports related shapes 142 of FIG. 22F.

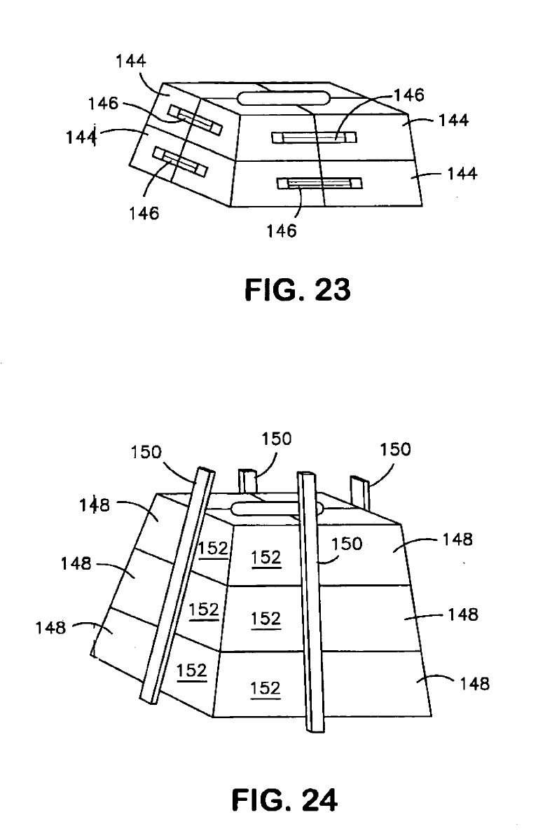

Turning now to FIG. 23, there is shown a multi-tiered embodiment having mold blocks 144 arranged together. In this embodiment, there is an alternative form of external support and is shown as straps 146 that span and attach together abutting adjacent mold blocks 144. With the FIG. 23 embodiment, the straps 146 may include buckles or other devices that connect the straps together and the straps 146 may be located between any two or more mold blocks 144.

Next, in FIG. 24, there is a further alternative form of external support and in this embodiment, the external supports for the mold blocks 148 comprise a plurality of rails 150 that are generally vertically oriented and which bear against the surfaces 152 of the mold blocks 148 to retain those mold blocks 148 in the assembled orientation.

In the use of the present invention, a plurality of mold blocks can be provided to a purchaser in a single package such that the package of the sand structure constructing components would include a plurality of the mold blocks along with an external support with the inner surfaces of the mold blocks forming a particular desired shape to create a particular shape of sand structure.

Therefore, the user can purchase a particular package containing the necessary mold blocks and external supports that the user can employ in accordance with the method of the present invention to construct a sand structure, along with a weapon or weapons that can be used by a user or other child to destroy the structure constructed by the use of the mold blocks and external supports. Preferably, the package also contains instructions to the purchaser as to how to use the mold blocks contained within the package to construct the particular sand structure illustrated on the package as well as any other components necessary to carry out that construction.

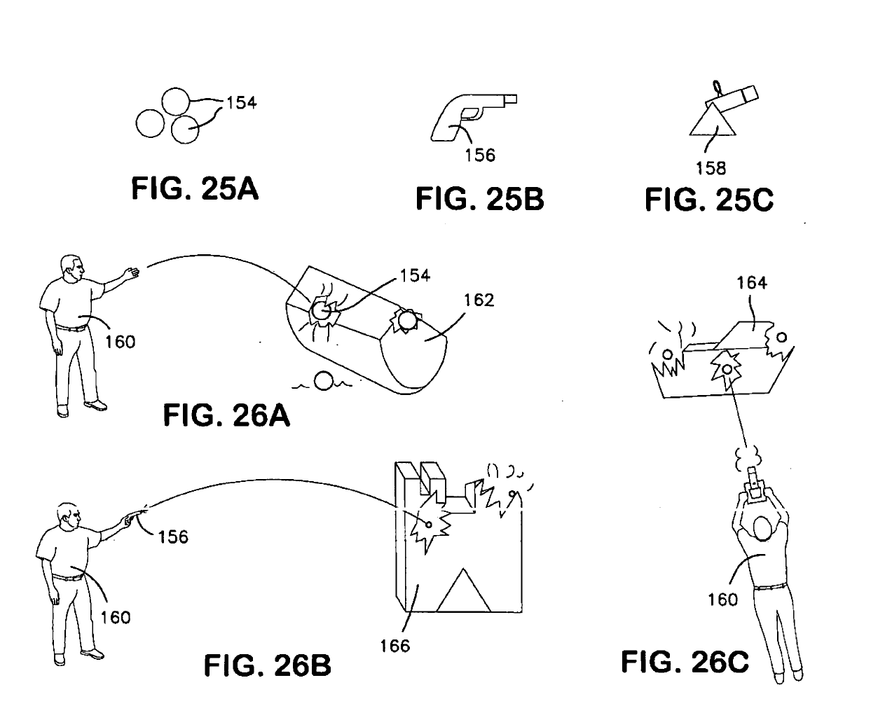

As a part of a game that can he played with the sand structures constructed with the use of the present invention, there can be provided to the user a weapon and that weapon can include those illustrated in FIGS. 25A-C, that is, toy simulated bombs 154, a toy gun 156 or a toy cannon 158 and one or all of those weapons can be supplied to the user to carry out the game along with any number of other weapons that would be enjoyable for use by a child in destroying a sand structure.

Next, in accordance with the game, there is shown in FIGS. 26A-26C, schematic views of a user 160 using each of the weapons illustrated in FIGS. 25A-25C, to destroy a submarine 162, a ship 164 and a castle 166.

Accordingly, the particular package can be sold to the user containing all of the necessary tools and components to carry out the game in constructing a sand structure as well as the weapons that can cause the destruction of that sand structure. In addition, the package can contain discovery objects that can be packed into and thus concealed in the sand as it is packed into an internal cavity formed by the internal surfaces of an assemble of mold blocks so that the objects can be discovered by a child within the sand structure thereby formed.

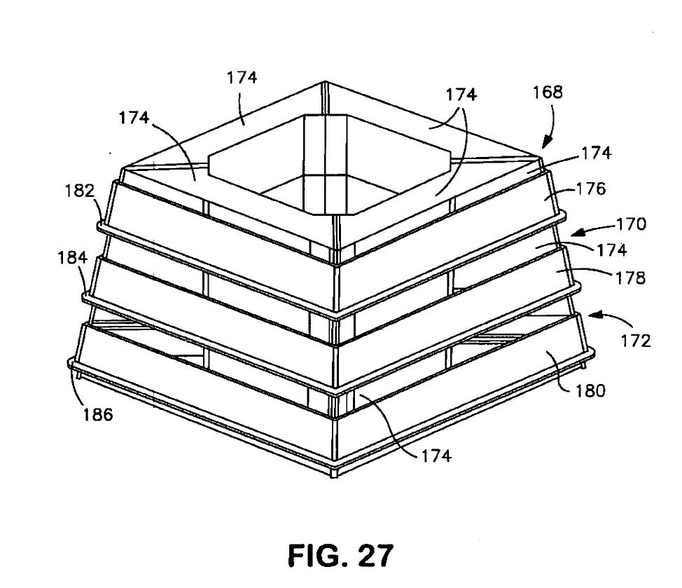

Turning now to FIG. 27, there is shown a perspective view of an exemplary embodiment where there are multiple tiers of mold blocks, there is an upper tier 168, a middle tier 170 and a lower tier 172 comprised of mold blocks 174. As also can be seen, the mold blocks 174 that make up the upper, middle and lower tiers 168, 170 and 172 are retained by an upper casing 176, a middle casing 178 and a lower casing 180 and which hold the mold blocks 174 in position as the sand is serially packed into the cavity between the mold blocks 174. As also can be seen, each of the casings 176, 178 and 180 has an outwardly extending flange 182, 184 and 186 along the lower edge of the outer perimeter of each of the casings. As such the presence of the flanges 182, 184 and 186 facilitates pushing the casings downwardly to fit around the mold blocks 174 and to remove the casings 176, 178, 180 before the mold blocks 174 are removed to reveal the sand structure. With respect to any one tier, the flange may encircle the entire perimeter of the casing enclosing a tier of mold blocks or can extend only partially therearound.

As a further feature and which can be appreciated by resort to FIG. 27, each of the individual mold blocks 174 can have a different profile of mold and thus create a different impression on the sand as it is packed into the cavity formed by the plurality of differing mold blocks. Thus, as such, with the individual mold blocks 174 being interchangeable with other mold blocks on the same level or tier, a puzzle can be devised therein that would be different, or solved, by the particular placing of a mold block at a specific position along a tier and with respect to different tiers. Accordingly, the puzzle could be to make up a particular sand structure depending on the location that the user places a mold block and that the user must place the individual mold blocks in the correct location oriented with other mold blocks in order to achieve the desired structure.

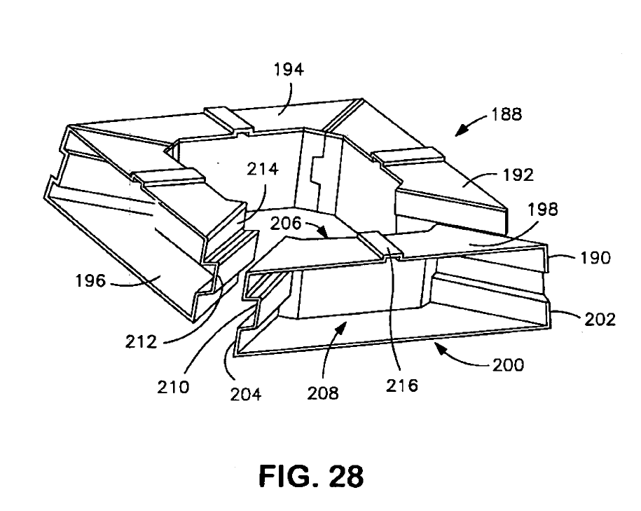

Turning next to FIG. 28, there is shown a perspective view of a typical tier 188 having mold blocks 190, 192, 194 and 196 that are illustrated in a partially assembled condition. Taking one of the mold blocks 190 as typical of all of the mold blocks, there is a top surface 198, a bottom surface 200 and side surfaces 202 and 204. There is also an internal surface 206 that provides the molding design for the ultimate sand structure. In this exemplary embodiment, the mold block 190 is hollow, that is, there is an open space 208 in the area facing outwardly from the internal surface 206. As such, the overall weight of a mold block is greatly reduced and, as will later be explained, the open space 208 enables multiple mold blocks to be nested together compactly for shipment or storage and reduces the size of the overall packaging for sale thereof.

As also can be seen, there is an interlocking system between the side surfaces of adjacent mold blocks. As exemplary of the interlocking system, there is a keyway 210 formed in the side surface 204 of the mold block 200 and a corresponding and dimensionally interlocking key 212 formed on the side surface 214 of the mold block 196. When, therefore, the tier 188 is assembled and adjacent mold blocks are brought into mutual contact, the key 212 enters into and interlocks with the keyway 210. That relationship is provided in a similar manner with respect to all of the mold blocks 190, 192, 194 and 196.

The purpose of the interlocking is to align all of the mold blocks of a particular tier so that the internal mold is formed in a consistent manner and also to require the removal of each mold block to a lateral sliding motion outwardly in the disassembly of the system of molding a sand structure that is the movement of the mold blocks during their removal is constrained so as to require pulling the mold blocks laterally outwardly and which minimizes the risk of damage to the sand structure.

That interlocking system providing for the constrained lateral movement is also facilitated by an interlocking system between tiers themselves, that is, vertically and, as can be seen in FIG. 28, there is a key 216 formed in the top surface 198 of the mold block 190 that interlocks with a corresponding keyway (not shown in FIG. 28) in a mold block of the next higher tier of mold blocks.

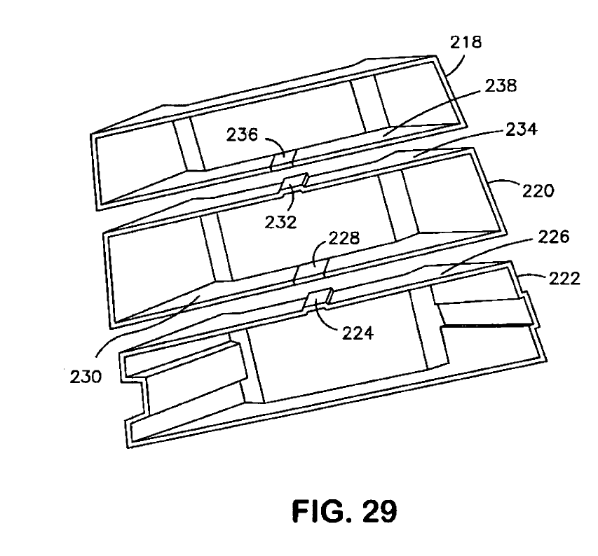

Turning then to FIG. 29, there is shown a rear view of an upper mold block 218 a middle mold block 220 and a lower mold block 222 as illustrative of typical vertically aligned mold blocks of multiple tiers, there obviously being three more sets of mold blocks to complete this particular mold block system. In FIG. 29, however, there can seen a key 224 formed in the upper surface 226 of the lower mold block 222 and which interfits into a keyway 228 formed in the lower surface 230 of the middle mold block 220. In addition, there is a key 232 formed in the upper surface 234 of the middle mold block 220 that interfits into a keyway 236 formed in the lower surface 238 of the upper mold block 218.

Accordingly, it can be seen that the vertical interlocking of mold blocks of vertical contacting tiers stabilizes and aids in the alignment of the construction of the present system as well as provide an aid to the removal of the mold blocks in a direction laterally outwardly as the mold block assembly is disassembled since the orientation of the key and keyway interlocking occurs along a line that extends generally radially outwardly from the geometric center of the mold block tiers where the sand structure is located.

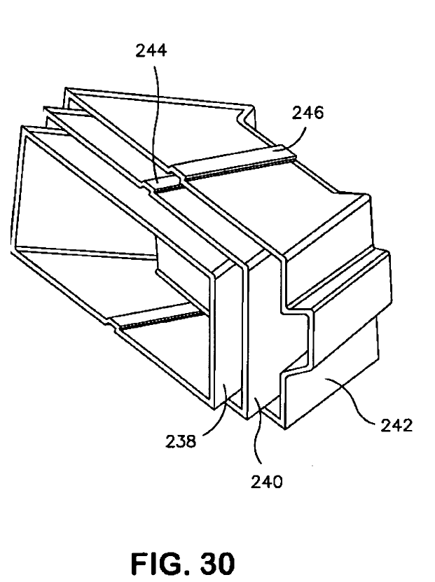

Turning next to FIG. 30, there is a perspective view of an exemplary upper mold block 238, a middle mold block 240 and a lower mold block 242 that are illustrated in their nested orientation with respect to each other. It can be seen that the upper mold block 238 fits into the open space of the middle mold block 240 and which, in turn fits into the open space of the lower mold block 242 (note the open spaces illustrated in FIG. 28). In the construction of the mold blocks themselves, to facilitate the nesting feature, the upper mold block 240 is designed to be a bit narrower than the middle mold block 240 and which, in turn, is designed to be a bit narrower than the lower mold block 242. In addition, the key 244 of the middle mold block 240 is narrower than the key 246 of the lower mold block 242 to aid in the nesting of the mold blocks together. The same can be true of a system with horizontal keys and keyways on each level.

Accordingly, with this nesting feature and the mold blocks having open spaces, a typical mold block system of twelve mold blocks can be reduced to four stacks of three blocks, for example and the stacks are relatively compact for storage, shipment, packaging and sale. With such feature, the open spaces in the mold blocks can be used as a handle to pull the mold blocks away from the sand structure. The mold blocks themselves can be constructed of injected molded plastic.

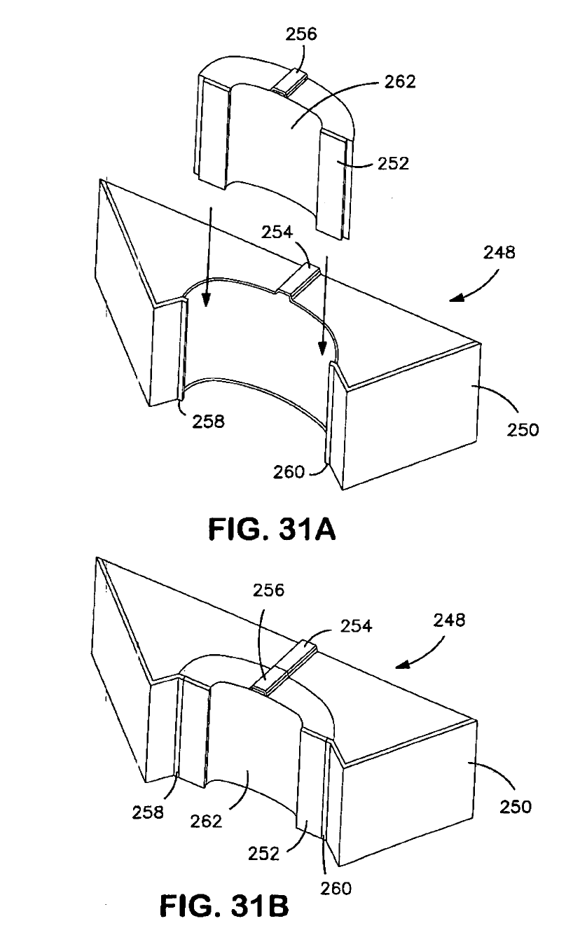

Turning now to FIGS. 31A and 31B, there is a perspective view of a further exemplary embodiment of the present invention wherein the mold block 248 is constructed of two components, that is, there is a base block 250 and a replaceable face plate 252. The mold block 248 of FIGS. 31A and 31B can be any of the mold blocks of a mold block system since the feature of interchangeable face plates is applicable to any or all of the mold blocks used in creating a sand structure.

As such, the base block 250 can have a key 254 that aligns with a key 256 on the replaceable face plate and the keys 254, 256 and keyways (not shown in FIGS. 31A and 31B) are used in the manner described with respect to FIGS. 28 and 29.

The replaceable face plate 252 is removably attached to the base block 250 and that means of attachment can be by sliding the removable face plate 252 into a receptacle formed by flanges 258, 260 so that the removable face plate 252 can be readily removed and replaced by that sliding motion, snapped into place or installed from the bottom. In an alternate embodiment, the face plate 252 can be snapped onto the base block 250. As seen, the interior surface 262 of the removable face plate 252 normally has the particular mold that is desired to be used to shape the sand that is poured into a completed mold block system and, therefore, by making the face plate 252 replaceable, different faces can be used with a base block 250 to change the exterior design of the completed sand structure.

By the use of replaceable face plates, therefore, the user need only purchase a set of base blocks along with a set of face plates that may be different. Thus, face plates that are compatible with the base blocks can be sold separately and the user has the versatility of simply buying differing sets of face plates, thereby, saving the cost of having to buy an entire set of mold blocks each time a different sand structure is desired to be constructed.

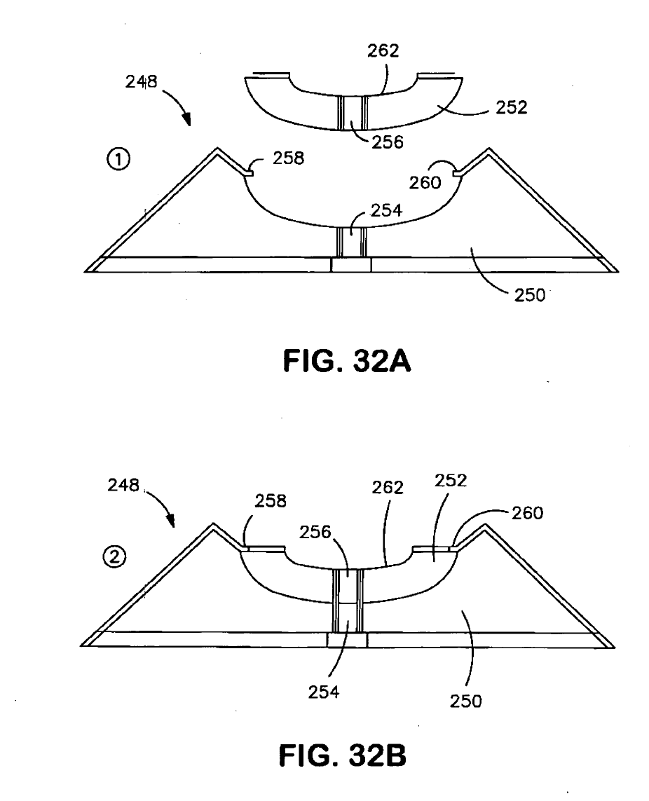

Turning finally to FIGS 32A and 32B, there is shown top views of the mold block 248 of FIGS. 31A and 31B, both unassembled and assembled, and illustrating the location and extent of the flanges 258, 260 that hold the replaceable face plate 252 to the base block 250.

Those skilled in the art will readily recognize numerous adaptations and modifications which can be made to the system of constructing sand structures and packages of tools to construct sand structures of the present invention which will result in an improved system and package, yet all of which will fall within the scope and spirit of the present invention as defined in the following claims. Accordingly, the invention is to be limited only by the following claims and their equivalents.

1. A system for producing a structure, said system comprising a plurality of mold blocks having inner surfaces shaped in a desired configuration and outer surfaces, the mold blocks adapted to be arranged generally contiguously together to create an internal cavity having a desired shape by the collective inner surfaces of the mold blocks and at least one external support adapted to retain the mold blocks in their arranged position.

2. The system of claim 1 wherein the mold blocks are sand mold blocks and the structure is a sand structure.

3. The system of claim 1 wherein the external support comprises a plurality of upstanding rails contacting the external surfaces of a least some of the mold blocks.

4. The system of claim 1 wherein the external support comprises a plurality of straps or buckles that span and are affixed to adjacent mold blocks.

5. The system of claim 1 wherein the arranged mold blocks form an outer perimeter and the external support comprises an outer casing that at least partially surrounds the outer perimeter thereby formed.

6. The system of claim 5 wherein the outer perimeter of the mold blocks and the outer casing both taper inwardly in the upward direction.

7. The system of claim 1 wherein at least one of the mold blocks has an interlocking device to interlock adjacent mold blocks together.

8. The system of claim 7 wherein the interlocking device comprises a guide peg provided on a mold block that interfits into a guide notch formed on an adjacent mold block.

9. The system of claim 1 wherein at least one of the mold blocks has a surface configuration to facilitate a user gripping the mold block.

10. The system of claim 1 wherein the mold blocks are adapted to be arranged in a plurality of vertical tiers or levels.

11. The system of claim 10 wherein an uppermost tier has a curved surface and a lower perimeter adapted to fit into an inwardly tapered opening in the next lower tier.

12. The system of claim 10 further including a plurality of outer casings, each of the outer casings at least partially surrounding a tier of the plurality of vertical tiers or levels.

13. The system of claim 1 wherein the collective inner surfaces form a puzzle such that the mold blocks must be assembled in a particular orientation to achieve the desired sand structure or structures.

14. A package of sand molding tools for constructing a sand structure, the package comprising:
a plurality of mold blocks having inner surfaces shaped in a desired configuration and having outer surfaces, the mold blocks adapted to be arranged generally contiguously together to create an internal cavity having a desired shape by the collective inner surfaces of the mold blocks and further including at least one external support adapted to retain the mold blocks in their arranged position.

15. The package of sand molding tools as defined in claim 14 wherein the package contains a plurality of mold blocks wherein at least one of the mold blocks is adapted to interlock with another mold block to become affixed together.

16. The package of sand molding tools as defined in claim 14 wherein the at least one external support comprises an outer casing adapted to at least partially surround the collective outer surfaces of mold blocks when arranged together.

17. The package of sand molding tools as defined in claim 14 wherein the package includes at least one weapon that is adapted to be used to destroy a sand structure constructed by the use of mold blocks.

18. The system of claim 1 wherein the at least one external support has an outwardly extending flange that extends at least partially around the outer perimeter of the mold blocks.

19. The system of claim 1 wherein each mold block is substantially hollow, having an open area facing outwardly from the inner surface such that one mold block can be nested into and interfit within the open area of another mold block.

20. The system of claim 1 wherein at least one mold block is comprised of a base block and a removable face plate having the inner surface shaped in the desired configuration.

21. The system of claim 20 wherein at least one mold block has a removable face plate that is slidably attached or snaps on to the base block.

22. The system of claim 1 wherein at least one mold block is interlocked to at least one other mold block by means of a key and keyway.

23. The system of claim 22 wherein the at least one mold block is interlocked to at least one other mold block vertically oriented with respect to the at least one mold block.

24. The system of claim 22 wherein the at least one mold block is interlocked to at least one other mold block horizontally oriented with respect to the at least one mold block.

25. The system of claim 22 wherein the at least one mold block is interlocked to at least two other mold blocks, one of the at least two other mold blocks being vertically oriented with respect to the at least one mold block and the other of the two at least two mold blocks being horizontally oriented with respect to the at least one mold block.

25. (canceled)

26. A package of sand molding tools for constructing a sand structure, the package comprising:
a plurality of mold blocks having outer surfaces, a plurality of face plates adapted to be slidably attached or snapped on to the mold blocks to form an inner surface thereof, the mold blocks adapted to be arranged generally contiguously together to create an internal cavity having a desired shape by the collective inner surfaces of the face plates and further including at least one external support adapted to retain the mold blocks in their arranged position.

27. The package of claim 26 wherein the at least one external support comprises one or more of a rail, a strap or a buckle.

28. A package of individual face plates adapted to be affixed to mold blocks for creating a sand structure.
